(19) United States
(12) Patent Application Publication
(10) Pub. No.: US 2017/0154173 A1
(43) Pub. Date: Jun. 1, 2017

(54) Array password authentication system and method thereof

(71) Applicant: Chao-Hung WANG, Taichung City (TW)

(72) Inventor: Chao-Hung WANG, Taichung City (TW)

(21) Appl. No.: 14/953,032

(22) Filed: Nov. 27, 2015

(51) Int. Cl. G06F 21/31; G06F 21/36

(52) U.S. Cl. CPC G06F 21/31; G06F 21/36

(57) ABSTRACT

An array password authentication method includes six authentication steps. The first authentication step is for inputting stored passwords into a system. The second authentication step is for displaying a plurality of first random codes arranged to form a first square matrix. One of the first random codes, is selected as a first inputting password. The third authentication step is for comparing the first stored password with the first inputting password. The fourth authentication step is for executing an anti-mistouch verification. The fifth authentication step is for displaying a plurality of second random codes arranged to form a second square matrix. One of the second random codes is selected as a second inputting password. The sixth authentication step is for comparing the second stored password with the second inputting password. If the second stored password and the second inputting password are different, the system is locked.

### BACKGROUND

Technical Field

The present disclosure relates to a password authentication system and a password authentication method. More particularly, the present disclosure relates to an array password authentication system and an array password authentication method.

Description of Related Art

Electronic devices, such as mobile phones and tablet computers, are now indispensable tools in daily life of modern people. Each of the electronic devices has at least one authentication system to protect system information and personal data. A keyboard or a touch screen is usually used to input a password on the electronic devices. In addition, an authentication system utilizing the keyboard or the touch screen is also applied in a variety of areas such as access control devices, safety deposit boxes, commercial businesses, banks administrative affairs, communications and the like, thus security and convenience of the authentication system become more important.

A physical keyboard or a virtual keyboard on the touch screen is usually used to enter the password's on most conventional password authentication systems. However, due to fixed position of input keys of the physical keyboard or the virtual keyboard on the touch screen, there is a great risk that other people can easily guess the password from the motions of the user's hands, thereby the password may be easily leaked out to a third party. Furthermore, if the user enters an incorrect password, the conventional password authentication system will request the user to re-enter a correct password. However, the conventional password authentication system usually sets limited password re-entering times. If the password re-entering times reach or exceed an upper limit number, the password authentication system will be locked. Such conventional password authentication system provides the opportunities for other people to steal the users password and have a high security risk.

### SUMMARY

Therefore, the present disclosure provides the array password authentication system and method thereof. The array password authentication system and method thereof can effectively improve the security of the array password authentication system by using double password verifications combined with the anti-mistouch verification, so that the risk of stealing of a correct password is greatly reduced. In addition, the array password authentication system and method thereof of the present disclosure can effectively prevent unwanted locking of the array password authentication system caused by entering a wrong password from the user.

According to one aspect of the present disclosure, an array password authentication method for verifying a user's inputting passwords includes a first authentication step, a second authentication step, a third authentication step, a fourth authentication step, a fifth authentication step and a sixth authentication step. The first authentication step is for inputting a first stored password, a second stored password and an anti-mistouch stored password into an array password authentication system. The second authentication step is for displaying a plurality of first random codes arranged to form a first square matrix. The first random codes include the first stored password, and one of the first random codes is selected as a first inputting password by the user. The third authentication step is for comparing the first stored password with the first inputting password. If the first stored password and the first inputting password are the same, the array password authentication system is opened. If the first stored password and the first inputting password are different, the array password authentication system executes an anti-mistouch verification. The fourth authentication step is for executing the anti-mistouch verification by the array password authentication system. The anti-mistouch verification is for inputting an anti-mistouch inputting password by the user. The array password authentication system compares the anti-mistouch inputting password with the anti-mistouch stored password. If the anti-mistouch inputting password and the anti-mistouch stored password are different, the array password authentication system executes the anti-mistouch verification until the anti-mistouch inputting password is equal to the anti-mistouch stored password. The fifth authentication step is for displaying a plurality of second random codes arranged to form a second square matrix. The second random codes include the second stored password. One of the second random codes is selected as a second inputting password by the user. If the anti-mistouch inputting password and the anti-mistouch stored password are the same in the fourth authentication step, the array password authentication system performs the fifth authentication step. The sixth authentication step is for comparing the second stored password with the second inputting password. If the second stored password and the second inputting password are the same, the array password authentication system executes the second authentication step. If the second stored password and the second inputting password are different, the array password authentication system is locked.

Hence, the array password authentication system and method thereof of the present disclosure can effectively improve the security of the array password authentication system by using double password verifications combined with the anti-mistouch verification, so that the risk of stealing of a correct password is greatly reduced. Moreover, the array password authentication system and method thereof of the present disclosure can effectively prevent unwanted locking of the array password authentication system caused by entering a wrong password from the user.

According to the other embodiment of the aspect of the present disclosure, one of the first random codes is text, a number, a symbol or a graph. One of the second random codes is a text, a number, a symbol or a graph. A number of the first stored password is one or more, and a number of the first inputting password is one or more. A number of the second stored password is one or more, and a number of the second inputting password is one or more. A size of the first square matrix is K×L. K is larger than or equal to 3, and L is larger than or equal to 3. A size of the second square matrix is M×N. M is larger than or equal to 3, and N is larger than or equal to 3. The anti-mistouch stored password is generated by a computer or the user. The array password authentication system is used on a mobile phone, a computer or an electronic instrument, If a number of a selecting time of the first inputting password is larger than a number of re-entering times, the array password authentication system is locked. The number of re-entering times is larger than or equal to 2.

According to another aspect of the present disclosure, an array password authentication system includes a storage module, an inputting module and a verification module. The storage module is configured to store a first stored password, a second stored password and an anti-mistouch stored password. The inputting module includes a display unit and a touch unit. The display unit sequentially displays a plurality of first random codes arranged to form a first square matrix, an anti-mistouch stored password and a plurality of second random codes arranged to form a second square matrix. The first random codes include the first stored'password, and the second random codes include the second stored password. The touch unit reads a first inputting password, an anti-mistouch inputting password and a second inputting password. The verification module is electrically connected to the storage module and the inputting module. The verification module compares the first stored password with the first inputting password. The verification module compares the anti-mistouch stored password with the anti-mistouch inputting password. The verification module compares the second stored password with the second inputting password.

Hence, the array password authentication system and method thereof of the present disclosure cart effectively improve the security of the array password authentication system by using double password verifications combined with the anti-mistouch verification, so that the risk of stealing of a correct password is greatly reduced. Furthermore, the array password authentication system and method thereof of the present disclosure are very dimple for any user and are very suitable for any kind of password authentication systems.

According to the other embodiments of the aspect of the present disclosure, one of the first random codes is a text, a number, a symbol or a graph. One of the second random codes is a text, a number, a symbol or a graph. A number of the first stored password is one or more, and a number of the first inputting password is one or more. A number of the second stored password is one or more, and a number of the second inputting password is one or more. A size of the first square matrix is K×L. K is larger than or equal to 3, and L is larger than or equal to 3. A size of the second square matrix is M×N. M is larger than or equal to 3, and N is larger than or equal to 3.

### BRIEF DESCRIPTION OF THE DRAWINGS

The present disclosure can be more fully understood by reading the following detailed description of the embodiment, with reference made to the accompanying drawings as follows:

FIG. 1 is a flow chart showing an array password authentication method according to one embodiment of the present disclosure; FIG. 2 is a block diagram showing an array password authentication system according to one embodiment of the present disclosure;

FIG. 3 is a flow chart showing an array password authentication method according to another embodiment of the present disclosure;

FIG. 4A is a schematic diagram showing plural first random codes of a first square matrix displayed on a display unit in FIG. 2;

FIG. 4B is a schematic diagram s bowing plural second random codes of second square matrix displayed on the display unit in FIG. 2; and

FIG. 4C is a schematic diagram showing an anti-mistouch stored password and an anti-mistouch inputting password displayed on the display unit in FIG. 2.

### DETAILED DESCRIPTION

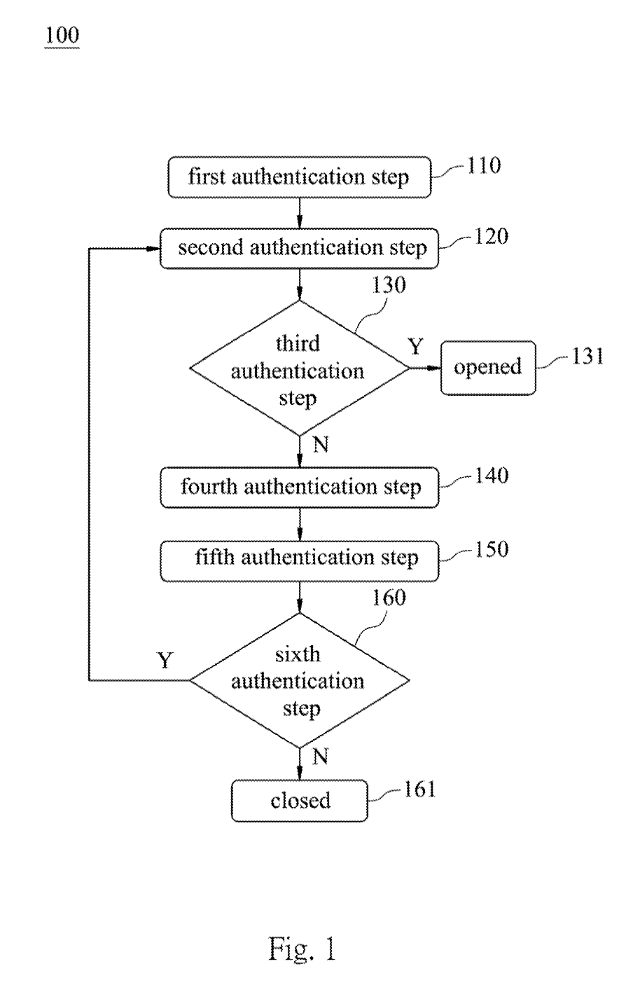

FIG. 1 is a flow chart showing an array password authentication method 100 according to one embodiment of the present disclosure; and FIG. 2 is a block diagram showing an array password authentication system 200 according to one embodiment of the present disclosure. In FIG. 1, the array password authentication method 100 includes a first authentication step 110, a second authentication step 120, a third authentication step 130, a fourth authentication step 140, a fifth authentication step 150 and a sixth authentication step 160.

The first authentication step 110 is for inputting a first stored password 211, a second stored password 212 and an anti-mistouch stored password 213 into the array password authentication system 200 by a user. A number of the first stored password 211 may be one or more, and a number of the second stored password 212 may be one or more.

The second authentication step 120 is for displaying plural first random codes arranged to form a first square matrix on the array password authentication system 200. The first random codes include the first stored password 211, and one of the first random codes is selected as a first inputting password 223 by the user. In addition, one of the first random codes may be a text, a number, a symbol or a graph. A number of the first inputting password 223 is one or more. The number of the first stored password 211 may be equal to the number of the first inputting password 223. A size of the first square matrix is K×L where K is larger than or equal to 3, and L is larger than or equal to 3.

The third authentication step 130 is for comparing the first stored password 211 with the first inputting password 223. If the first stored password 211 and the first inputting password 223 are the same, the array password authentication system 200 executes a step 131 which represents that the array password authentication system 200 is opened. In other words, the array password authentication system 200 is successfully unlocked by the user when the first stored password 211 is equal to the first inputting password 223. On the other hand, if the first stored password 211 and the first inputting password 223 are different, the array password authentication system 200 executes an anti-mistouch verification of the fourth authentication step 140.

The fourth authentication step 140 is for executing the anti-mistouch verification by the array password authentication system 200. The anti-mistouch verification is for in putting an anti-mistouch in putting password 225 by the user. The array password authentication system 200 compares the anti-mistouch inputting password 225 with the anti-mistouch stored password 213. If the anti-mistouch inputting password 225 and the anti-mistouch stored password 213 are different, the array password authentication system 200 repeatedly executes the anti-mistouch verification until the anti-mistouch in putting password 225 is equal to the anti-mistouch stored password 213. On the other hand, if the anti-mistouch inputting password 225 and the anti-mistouch stored password 213 are the same, the array password authentication system 200 executes the fifth authentication step 150. The anti-mistouch stored password 213 can be generated by a computer or the user.

The fifth authentication step 150 is for displaying plural second random codes arranged to form a second square matrix on the array password authentication system 200. The, second random codes include the second stored password 21 One of the second random codes is selected as a second inputting password 224 by the user. One of the second random codes is a text, a number, a symbol or a graph. A number of the second inputting password 224 is one or more. The number of the second stored password 212 may be equal to the number of the second inputting password 224. A size of the second square matrix is M×N where M is larger than or equal to 3, and N is larger than or equal to 3.

The sixth authentication step 160 is or comparing the second stored password 212 with the second inputting password 224. If the second stored password 212 and the second inputting password 224 are the same, the array password authentication system 200 executes the second authentication step 120. On the contrary, if the second stored password 212 and the second inputting password 224 are different, the array password authentication system 200 executes a step 161 which represents that the array password authentication system 200 is locked. In other words, the access of the array password authentication system 200 may fail because the user enters the wrong, second inputting password 224, so that the array password authentication system 200 is locked and closed.

In FIG. 2, the array password authentication system 200 which can be used on a mobile phone, the computer or an electronic instrument includes a storage module 210, an inputting module 220 and a verification module 230. The storage module 210 is configured to store the first stored password 211, a second stored password 212 and the anti-mistouch stored password 213. The inputting module 220 includes a display unit 221 and a touch unit 222. The display unit 221 sequentially displays plural interface passwords IP which include the first random codes arranged to form the first square matrix, the anti-mistouch stored password 213 and the second random codes arranged to form the second square matrix. The first random codes include the first stored password 211, and the second random codes include the second stored password 212. The touch unit 222 reads plural inputting passwords which include a first inputting password 223, the anti-mistouch inputting password 225 and the second inputting password 224. The verification module 230 is electrically connected to the storage module 210 and the inputting module 220. The verification module 230 compares the first stored password 211 with the first inputting password 223. In detail, the verification module 230 executes the third authentication step 130 for comparing the first stored password 211 with the first inputting password 223. If the first stored password 211 and the first inputting password 223 are the same, the verification module 230 of the array password authentication system 200 is opened and successfully unlocked. On the other hand, if the first stored password 211 and the first inputting password 223 are different, the verification module 230 of the array password authentication system 200 executes an anti-mistouch verification of the fourth authentication step 140. Moreover, the verification module 230 compares the anti-mistouch stored password 213 with the anti-mistouch inputting password 225. In detail, the verification module 230 executes the fourth authentication step 140 for comparing the anti-mistouch stored password 213 with the anti-mistouch inputting password 225. If the anti-mistouch inputting password 225 and the anti-mistouch stored password 213 are different, the verification module 230 of the array password authentication system 200 repeatedly executes the anti-mistouch verification until the anti-mistouch inputting password 225 is equal to the anti-mistouch stored password 213. On the other hand, if the anti-mistouch inputting password 225 and the anti-mistouch stored password 213 are the same, the verification module 230 of the array password authentication system 200 executes the fifth authentication step 150. In addition, the verification module 230 compares the second stored password 212 with the second inputting password 224. In detail the verification module 230 executes the sixth authentication step 160 for comparing the second stored password 212 with the second inputting password 224. If the second stored password 212 and the second inputting password 224 are the same, the verification module 230 of the array password authentication system 200 executes the second authentication step 120. On the contrary, if the second stored password 212 and the second inputting password 224 are different, the verification module 230 of the array password authentication system 200 is locked and closed.

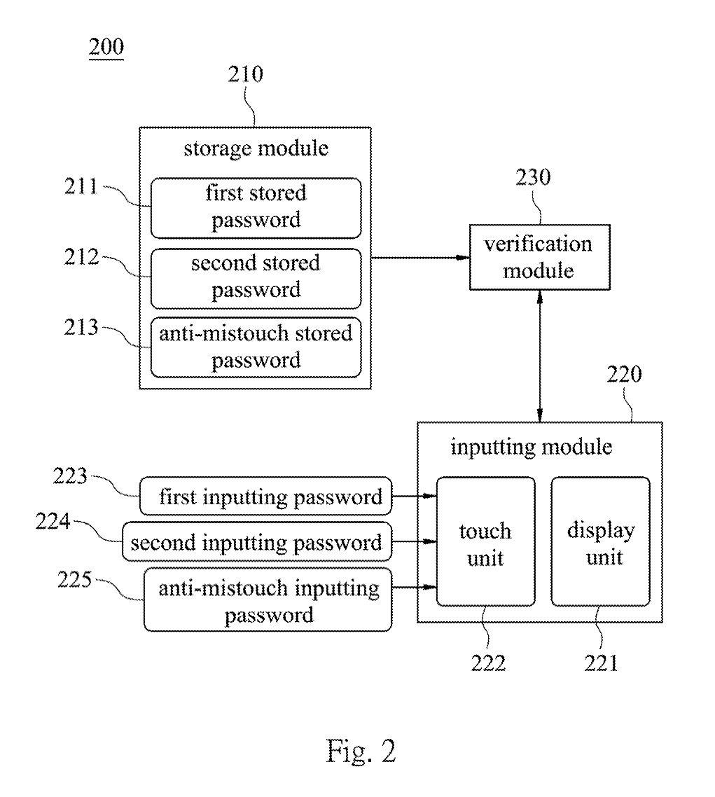

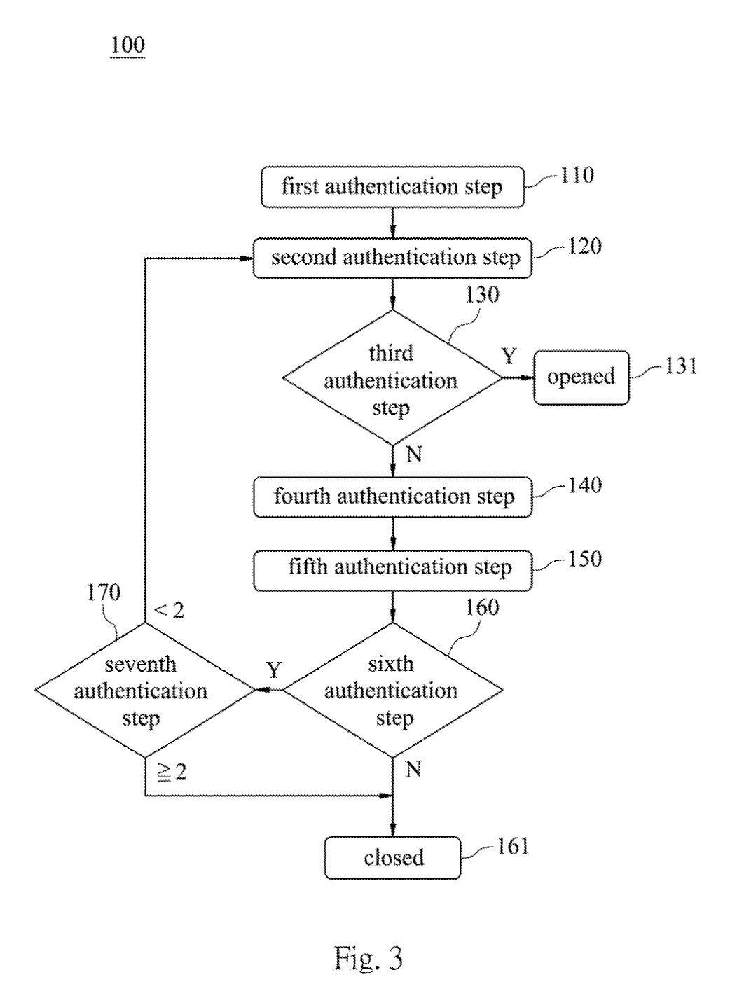

FIG. 3 is a flow chart showing an array password authentication method 100 according to another embodiment of the present disclosure. In FIG. 3, the array password authentication method 100 includes a first authentication step 110, a second authentication step 120, a third authentication step 130, a fourth authentication step 140, a fifth authentication step 150, a sixth authentication step 160 and a seventh authentication step 170. The detail of the first authentication step 110, the second authentication step 120, the third authentication step 130, the fourth authentication step 140, the fifth authentication step 150 and the sixth authentication step 160 is the same as the embodiments of FIG. 1 and will not be described again herein In FIG. 3 the array password authentication method 100 further includes the seventh authentication step 170 which is for checking a number of a selecting time of the first inputting password 223 by the array password authentication system 200. If the number of the selecting time of the first inputting password 223 is larger than a number of re-entering times, the array password authentication system 200 is locked, and the user will not be able to enter any password. The number of re-entering times is larger than or equal to 2. The larger the number of the selecting time of the first inputting password 223 is, the lower security of the array password authentication system 200 has.

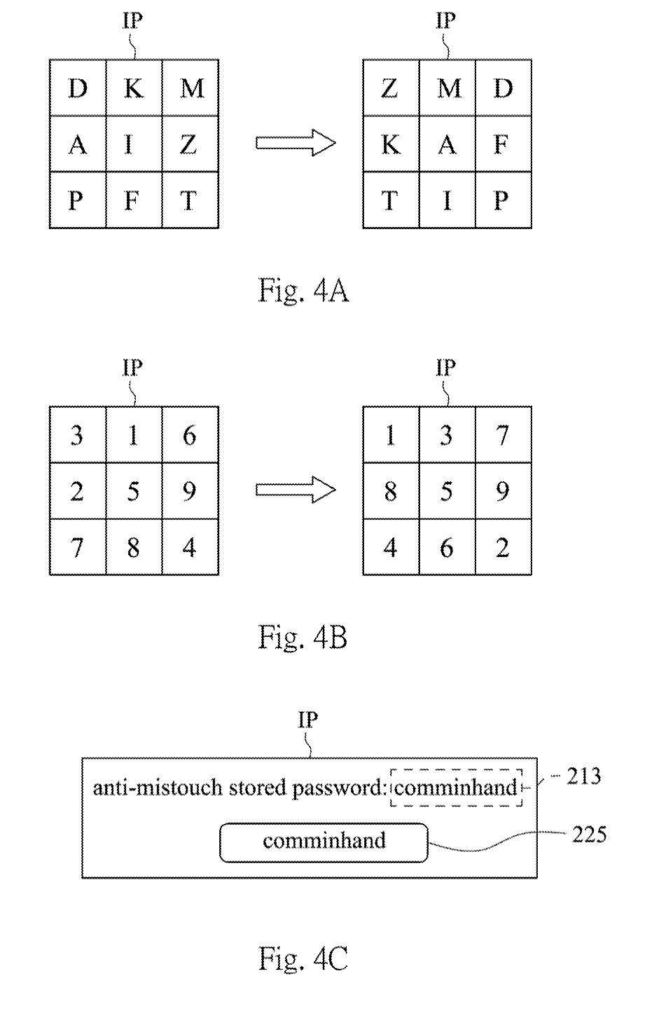

FIG. 4A is h schematic diagram showing plural first random codes of a first square matrix displayed on the display unit 221 in FIG. 2; and FIG. 4B is a schematic diagram showing plural second random codes of a second square matrix displayed on the display unit 221 in FIG. 2. In FIG. 4A, the interface password IP displayed on the display unit 221 is the first random codes arranged to form the first square matrix. In FIG 4B, the interface password IP displayed on the display unit 221 is the second random codes arranged to form the second square matrix. The first random codes include the first stored password 211, and the second random codes include the second stored password 212. For example the first stored password 211 is assigned a text character “M” by the user, and the first random codes are all text characters. The second stored password 212 is assigned a number “2” by the user, and the second random codes are all numbers. The size of the first square matrix is 3×3, and the size of the second square matrix is 3×3, so that the number of the first random codes and the number of the second random codes are all 9. When the first stored password 211 and the first inputting password 223 are different in the third authentication step 130 and the second stored pass word 212 and the second inputting password 224 are the same in the sixth authentication step 160, the array password authentication system 200 repeatedly executes the second authentication step 120 where the interface password IP displayed on the display unit 221 is the first random codes arranged to form the first square matrix, One of the first random codes is the text character “M”. All of the first random codes are randomly rearranged by the array password authentication system 200, so that the location of each of the first random codes of the interface password IP can be changed randomly.

FIG. 4C is a schematic diagram showing an anti-mistouch stored password 213 and an anti-mistouch inputting password 225 displayed on the display unit 221 in FIG. 2. In Fig, 4C, the anti-mistouch stored password 213 is assigned a word “comminhand” by the user. If the anti-mistouch inputting password 225 is assigned a same word “comminhand” by the user, the verification module 230 of the array password authentication system 200 executes the fifth authentication step 150. On the other hand, if the anti-mistouch inputting password 225 assigned by the user is not the word “comminhand”, the verification module 230 of the array password authentication system 200 repeatedly executes the anti-mistouch verification of the fourth authentication step 140 until the anti-mistouch inputting password 225 and the anti-mistouch stored password 213 are the same.

According to the aforementioned embodiments, the advantages of the present disclosure are described as follows. A first advantage is that the array password authentication system and method thereof of the present disclosure can effectively improve the security of the array password authentication system by using double password verifications combined with the anti-mistouch verification, so that the risk of stealing of a correct password is greatly reduced. A second advantage is that the array password authentication system and method thereof of the present disclosure can effectively prevent unwanted locking of the array password authentication system caused by entering a wrong password from the user. A third advantage is that the array password authentication system and method thereof of the present disclosure are very simple for any user and are very suitable for any kind of password authentication systems.

It will be apparent to those skilled in the art that various modifications and variations can be made to the structure of the present disclosure without departing from the scope or spirit of the disclosure, in view of the foregoing, it is intended that the present disclosure cover modifications and variations of this disclosure provided they fall within the scope of the following claims.

1. An array password authentication method for verifying a user's inputting passwords, the array password authentication method comprising:
performing a first authentication step for inputting a first stored password, a second stored password and an anti-mistouch stored password into an array password authentication system;
performing a second authentication step for displaying a plurality of first random codes arranged to form a first square matrix, wherein the first random codes comprise the first stored password, and one of the first random codes is selected as a first inputting password by the user;
performing a third authentication step for comparing the first stored password with the first inputting password, wherein if the first stored password and the first inputting password are the same, the array password authentication system is opened, and if the first stored password and the first inputting password are different, the array password authentication system executes an anti-mistouch verification;
performing a fourth authentication step for executing the anti-mistouch verification by the array password authentication system, wherein the anti-mistouch verification is for inputting an anti-mistouch inputting password by the us the array password authentication system compares the anti-mistouch inputting password with the anti-mistouch stored password, the anti-mistouch inputting password and the anti-mistouch stored password are different, the array password authentication system executes the anti-mistouch verification until the anti-mistouch inputting password is equal to the anti-mistouch stored password;
performing a fifth authentication step for displaying a plurality of second random codes arranged to form a second square matrix, wherein the second random codes comprise the second stored password, one of the second random codes is selected as a second inputting password by the user, and if the anti-mistouch inputting password and the anti-mistouch stored password are different in the fourth authentication step, the array password authentication system performs the fifth authentication step; and
performing a sixth authentication step for comparing the second stored password with the second inputting password, wherein if the second stared password and the second inputting password are the same, the array password authentication system executes the second authentication step, and if the second stored password and the second inputting password are different, the array password authentication system is locked.

2. The array password authentication method of claim 1, wherein one of the first random codes is a text, a number, a symbol or a graph.

3. The array password authentication method of claim 1, wherein one of the second random codes is a text, a number, a symbol or a graph.

4. The array password authentication method of claim 1, wherein a number of the first stored password is one or more, and a number of the first inputting password is one or ore.

5. The array password authentication method of claim 1, wherein a number of the second stored password is one or more, and a number of the second inputting password is one or more.

6. The array password authentication method of claim 1, wherein a size of the first square matrix is K×L, K is larger than or equal to 3, and L is larger than or equal to 3.

7. The array password authentication method of claim 1, wherein a size of the second square matrix is M×N, M is larger than or equal to 3, and N is larger than or equal to 3.

8. The array password authentication method of claim 1, wherein the anti-mistouch stored password is generated by a computer or the user.

9. The array password authentication method of claim 1, wherein the array password authentication system is used on a mobile phone, a computer or an electronic instrument.

10. The array password authentication method of claim 1, wherein if a number of a selecting time of the first inputting password is larger than a number of re-entering times, the array password authentication system is locked.

11. The array password authentication method of claim 10, wherein the number of re-entering times is larger than or equal to 2.

12. An array password authentication system applied for the array password authentication method of claim 1, the array password authentication system comprising;
a storage module configured to store a first stored password, a second stored password and an anti-mistouch stored password;
an inputting module comprising a display unit and a touch unit, wherein the display unit sequentially displays a plurality of first random codes arranged to form a first square matrix, an anti-mistouch stored password and a plurality of second random codes arranged to form a second square matrix, the first random codes comprise the first stored password, the second random codes comprise he second stored password, the touch unit reads a first inputting password, an anti-mistouch inputting password and a second inputting password; and
a verification module electrically connected to the storage module and the inputting module, wherein the verification module compares the first stored password with the first inputting password, the verification module compares the anti-mistouch stored password with the anti-mistouch inputting password, and the verification module compares the second stored password with the second inputting password.

13. The array password authentication system of claim 12, wherein one of the first random codes is a text, a number, a symbol or a graph.

14. The array password authentication system of claim 12, wherein one of the second random codes is a text, a number, a symbol or a graph.

15. The array password authentication system of claim 12, wherein a number of the first stored password is one or more, and a number of the first inputting password is one or more.

16. The array password authentication system of claim 12, wherein a number of the second stored password is one or more, and a number of the second inputting password is one or more.

17. The array password authentication system of claim 12, wherein a size of the first square matrix is K×L, K is larger than or equal to 3, and L is larger than or equal to 3.

18. The array password authentication system of claim 12, wherein a size of the second square matrix is M×N, M is larger than or equal to 3, and N is larger than or equal to 3.
